(19) United States
(12) Patent Application Publication
(10) Pub. No.: US 2007/0100541 A1
(43) Pub. Date: May 3, 2007

(54) SMART NAVIGATION SYSTEM USING PORTABLE MEMORY AND CONTROL METHOD THEREOF

(76) Inventors: Byong Yong KONG, Icheon-si (KR); Tae Su Jun, Icheon-si (KR)

Correspondence Address: IPLA P.A., 3580 WILSHIRE BLVD., 17TH FLOOR, LOS ANGELES, CA, 90010, US

(21) Appl. No.: 11/553,412

(22) Filed: Oct. 26, 2006

(30) Foreign Application Priority Data
Oct. 28, 2005 (KR) 10-2005-0102442

(51) Int. Cl. G01C 21/00

(52) U.S. Cl. 701/207

(57) ABSTRACT

Provided are a smart navigation system using a portable memory, and a control method thereof. The system includes the portable memory, and a navigation system. The portable memory stores special area information on a specific area. The navigation system has a map database for storing map data, and, when a current measured position is within the specific area, maps the special area information to the map data and displays the mapped special area information.

### CROSS REFERENCE

Applicant claims foreign priority under Paris Convention and 35 U.S.C. § 119 to the Korean Patent Application No. 10-2005-0102442, filed Oct. 28, 2005 with the Korean Intellectual Property Office.

### BACKGROUND OF THE INVENTION

1. Field of the Invention

The present invention relates to a navigation system, and more particularly, to a smart navigation system using a universal serial bus, which connects with a portable memory for storing special area information specialized for a specific area (Hereinafter, referred to as “specialized area”) and, in running in the specialized area, maps the special area information to map data and performs a road guidance, and a method for controlling the smart navigation system.

2. Description of the Related Art

In general, a navigation system includes a map database (DB) for storing map data in which a topography of the whole country and a land feature such as a road and a building mapped to each name, lot number, and various icons and graphics are mapped to a latitude and a longitude (Hereinafter, referred to as “position information”). The navigation system measures a self position using a global positioning system (GPS), searches the map DB for a partial extent of the map data including the measured position, and displays the searched map data. The navigation system receives a destination from a user, searches an optimal path from a current measured position to the destination using a path searching method, maps the searched path to the map data, and performs a road guidance along the mapped path. In general, the map DB is stored in a storage medium such as a flash memory like a compact flash (CF) memory and a security digital (SD) memory, or a compact disk (CD).

The map DB stored in the flash memory or the compact disk stores only a schematic topography, a road having a width more than a predetermined width, a subway station, a main building, and a main tourist resort due to a capacity limit of the storage medium.

Accordingly, there are many cases in which there does not exist information on a building searched by the user, for example, information on a restaurant and a tourist resort of a specialized area. In this case, there is a drawback in that the destination should be searched using another search method based on the lot number, and, even though the destination is searched, any information is not shown on a map displayed on a screen.

In order to solve the drawback, a large amount of area information should be all recorded in the map DB. However, a vast capacity of storage medium needs to record the large amount of area information in the map DB. In recent years, according to the need, a navigation system for storing the map DB in a large capacity of digital video disk (DVD) to satisfy the user is being put on market.

However, the navigation system using the DVD storage medium has a drawback in that high-priced DVD player and DVD storage medium should be purchased, and it is difficult to effectively manage the area information often changing, and map information should be updated at each predetermined time period.

### SUMMARY OF THE INVENTION

Accordingly, the present invention is directed to a smart navigation system using a portable memory and a control method thereof that substantially overcome one or more of the limitations and disadvantages of the conventional art.

One object of the present invention is to provide a smart navigation system using a universal serial bus, which connects with a portable memory for storing special area information specialized for a specific area and, in running in the specialized area, maps the special area information to map data and performs a road guidance, and a method for controlling the smart navigation system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a smart navigation system using a portable memory. The system includes the portable memory, and a navigation system. The portable memory stores special area information on a specific area. The navigation system has a map database for storing map data, and, when a current measured position is within the specific area, maps the special area information to the map data and displays the mapped special area information.

In another aspect of the present invention, there is provided a smart navigation system using a portable memory. The system includes the portable memory, and a navigations system. The portable memory stores special area information on a specific area. The navigations system has a map database for storing map data, and searches a path from a current measured position to a destination at the time of inputting the destination, and, when the searched path passes through the specific area, maps the special area information to the map data and displays the mapped area information at the time of guiding a path corresponding to the specific area.

In a further another aspect of the present invention, there is provided a smart navigation system using a portable memory, the system. The system includes the portable memory, and a navigation system. The portable memory stores special area information on a specific area. The navigation system has a map database for storing map data, and searches the special area information for a name having an inputted key word at the time of searching a destination, and, when the name having the inputted key word is searched, maps the special area information on the name to the map data and displays the mapped special area information.

In a still another aspect of the present invention, there is provided a method for controlling a smart navigation system using a portable memory. The method includes steps of checking a connection or a disconnection of the portable memory storing special area information on a specific area; in connection of the portable memory, determining whether or not a current measured position is within the specific area; and when the current measured position is within the specific area, mapping the special area information to map data, and displaying mapped special area information.

In a yet another aspect of the present invention, there is provided a method for controlling a smart navigation system using a portable memory. The method includes steps of: if a destination is inputted, searching a path from a current measured position to the destination; checking a connection or a disconnection of the portable memory storing special area information on a specific area; in connection of the portable memory, determining whether or not the searched path passes through the specific area; and when the searched path passes through the area, mapping the special area information to map data, and displaying the mapped special area information.

In a yet another aspect of the present invention, there is provided a method for controlling a smart navigation system using a portable memory. The method includes steps of: checking whether or not a key word for searching a destination is inputted by a user; when the key word is inputted, checking a connection or a disconnection of the portable memory storing special area information on a specific area; in connection of the portable memory, determining whether or not there is special area information having a name corresponding to the key word among the special area information; and if there is the name corresponding to the key word, mapping the special area information on the name to map data, and displaying the mapped special area information.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a diagram illustrating a construction of a smart navigation system using a portable memory according to the present invention;

FIG. 2 is a flowchart illustrating a method for controlling a smart navigation system using a portable memory according to a first exemplary embodiment of the present invention;

FIG. 3 is a flowchart illustrating a method for controlling a smart navigation system using a portable memory according to a second exemplary embodiment of the present invention; and

FIG. 4 is a flowchart illustrating a method for searching a destination in a smart navigation system using a portable memory according to an exemplary embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention suggests a scheme in which a portable memory for storing special area information on a specialized area is constructed to connect to a navigation system, thereby reading the special area information from the portable memory, mapping the read area information to map data, and displaying the mapped area information when a user runs in the specialized area or is on a destination or a searched path.

The special area information may be downloaded from a company providing the map data, a company selling the navigation system, or a website providing tourist information of each specialized area. The special area information may be stored in the portable memory such as a universal serial bus (USB) memory, a secure digital (SD) memory, and a compact flash (CF) memory. Even when the user rents a car from a car rental company, he/she can get and use the portable memory to store the special area information of the specialized area.

The special area information includes a name, a lot number, position information, and icon information of each specialized topography feature such as restaurants, main facilities, and main tourist resorts of the specialized area. Also, the special area information can include information on a road having a width less than a predetermined width, not recorded in a map database (DB) for the specialized area.

A construction of the smart navigation system using the portable memory and a control method thereof according to the present invention will be described with reference to the accompanying drawings below.

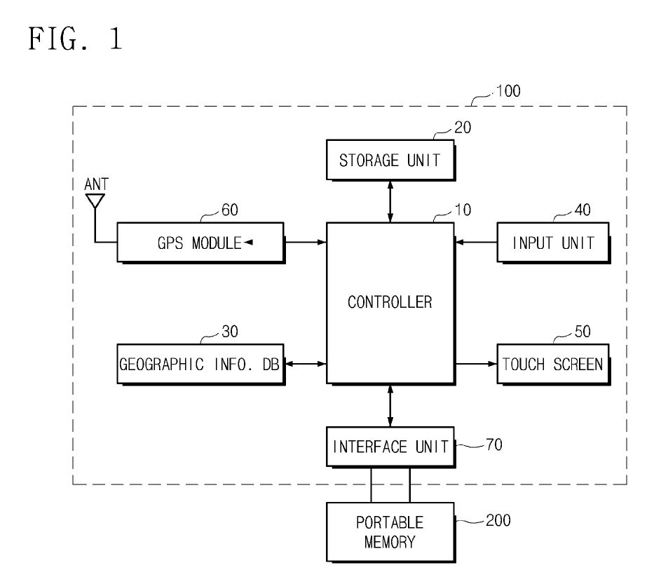

FIG. 1 is a diagram illustrating a construction of the smart navigation system using the portable memory according to the present invention.

The smart navigation system 100 using the portable memory according to the present invention includes a controller 10, a storage unit 20, the map database (DB) 30, a key input unit 40, a touch screen 50, a GPS module 60, and an interface unit 70.

The controller 10 controls a general operation of the smart navigation system according to the present invention.

The storage unit 20 includes a region for storing a control program for controlling the smart navigation system 100, and a region for temporarily storing data generated in execution of the control program.

The map DB 30 stores map data in which a topography of the whole country and a land feature such as a road and a building to which names, lot numbers, and graphic icons are mapped are mapped to the position information.

The input unit 40, a key input device, generates up/down scroll key data for searching the destination inputted by the user, shift key data for shifting the displayed map data, selection key data, and scaling down/up key data, and outputs the generated data to the controller 10. The input unit 40 can employ an infrared ray receiver for receiving an infrared ray signal including key data from a remote controller, and processing the received infrared ray signal.

The touch screen 50 displays an operation mode, an operation state, and the map data of the smart navigation system 100. The touch screen 50 displays a plurality of buttons or graphics for inputting and searching the destination, shifting the screen, and scaling down/up. The touch screen 50 outputs coordinate data on a position where one of the buttons is pressed, to the controller 10.

The GPS module 60 includes a GPS receiver (not shown) and a gyroscope. The GPS module 60 receives each GPS position signal from a plurality of GPS satellites through the GPS receiver, and calculates a self position using at least three GPS position signals. The GPS module 60 provides the calculated position information, and direction information measured by the gyroscope, to the controller 10.

The interface unit 70 includes a port for connecting with the portable memory 200, and performs a data communication between the portable memory 200 and the controller 10 under the control of the controller 10. The interface unit 70 can employ a USB host interface unit performing the data communication depending on a universal serial bus (USB) protocol. In the case of using the USB protocol, the portable memory 200 needs to employ a USB memory that is a USB device.

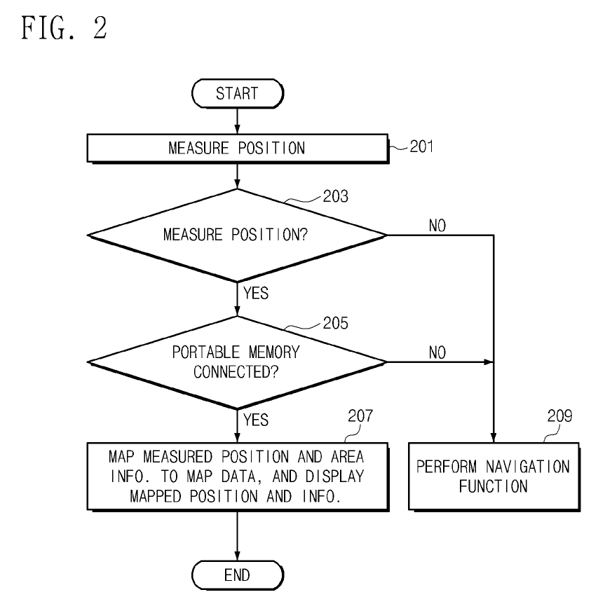

FIG. 2 is a flowchart illustrating a method for controlling the smart navigation system using the portable memory according to a first exemplary embodiment of the present invention.

In Step 201, the controller 10 measures the self position using the GPS module 60.

After that, in Step 203, the controller 10 determines whether or not it connects with the portable memory 200 through the interface unit 70.

If it is determined not to connect with the portable memory 200 in the Step 201, the controller 10 performs a general navigation function. Otherwise, the controller 10 proceeds with Step 205.

In the Step 205, the controller 10 determines whether or not a current measured position is within the specialized area of the special area information stored in the portable memory 200. For example, when the special area information is on Gangwon-do, it is determined whether or not the current measured position is an arbitrary position of Gangwon-do. The specialized area can be distinguished on a per-Do, Gu, Gun or Dong basis, or can be distinguished on a per-special tourist zone basis.

When the current position is not within the specialized area, the controller 10 performs the general navigation function in Step 209. When the current position is within the specialized area, the controller 10 maps the measured position and the special area information of the specialized area stored in the portable memory 200, to the map data, and displays the mapped position and area information on the touch screen 50 in Step 207.

In the above case, it is determined whether or not the user enters the specialized area on the basis of the measured position, but in case where a partial region of the map data displayed on the touch screen 50 includes the specialized area, the special area information can be mapped to the map data.

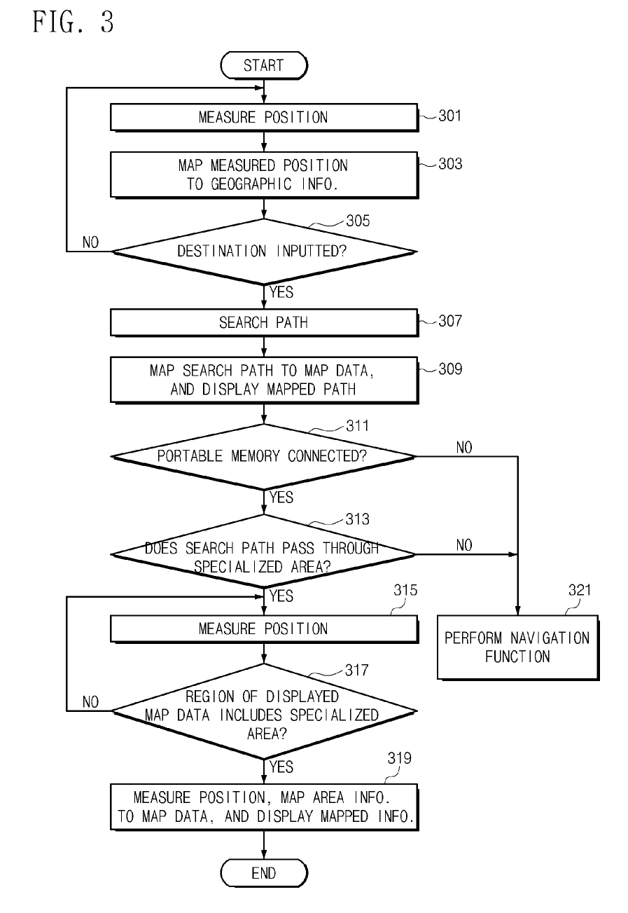

FIG. 3 is a flowchart illustrating a method for controlling a smart navigation system in a destination input mode using a portable memory according to a second exemplary embodiment of the present invention. A description will be made with reference to FIGS. 1 and 3 below.

In Step 301, a controller 10 measures a current position using a GPS module 60.

After the current position is measured, in Step 303, the controller 10 maps the measured position to map data, and displays the mapped position.

After the Step 303, the controller 10 checks whether or not a destination is inputted in Step 305. When the destination is inputted, the controller 10 searches a path from the current position to the destination in Step 307.

If the path is searched, in Step 309, the controller 10 maps the searched path to the map data, and displays the mapped path on a touch screen 50.

If the map data is displayed, in Step 309, the controller 10 determines whether or not it connects with a portable memory through an interface unit 70.

Not connecting with the portable memory in the Step 309, the controller 10 performs a general navigation function in Step 321. Connecting with the portable memory, the controller 10 proceeds with Step 313.

In the Step 313, the controller 10 determines whether or not the searched path passes through the specialized area of the special area information stored in the portable memory 200.

When it is determined that the searched path passes through the specialized area, the controller 10 measures the position in Step 315. The controller 10 checks whether or not a region of the map data currently displayed on the touch screen 50 includes the specialized area in Step 317.

When the region of the map data includes the specialized area, in Step 319, the controller 10 maps the displayed special area information of the specialized area among the special area information stored in the portable memory 200, and displays the mapped special area information.

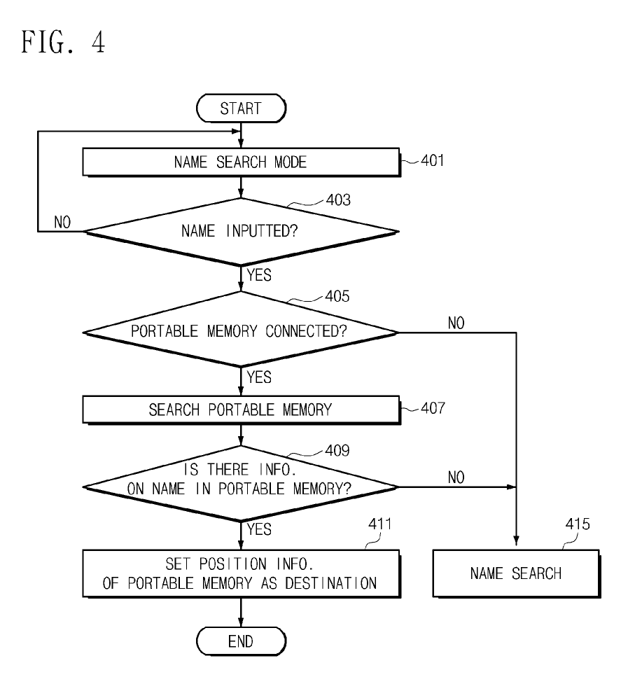

FIG. 4 is a flowchart illustrating a method for controlling a smart navigation system using a portable memory according to a third exemplary embodiment of the present invention. FIG. 4 illustrates a method for searching the destination in a name search mode using the portable memory. A description will be made with reference to FIGS. 1 and 4 below.

In Step 401, a controller 10 sets the name search mode when a name search command is inputted from an input unit 40.

When the name search mode is set, in Step 403, the controller 10 checks whether or not a name is selected or a key word is inputted through the input unit 40 and the touch screen 50.

When the name is selected or the key word is inputted in the Step 403, the controller 10 checks whether or not it connects with the portable memory 200 through an interface unit 70 in Step 405.

When it is checked that the controller 10 connects with the portable memory 200, it searches special area information stored in the portable memory 200, and determines whether or not there is information having the inputted name in Step 407.

If there is the information on the inputted name, the controller 10 sets a position of the special area information stored in the portable memory 200, as the destination in Step 411.

After the destination is set, the controller 10 maps the information on the name, that is, icon, graphic, or road information to the map data, using the method of the Steps 315 to 319 of FIG. 3, and displays the mapped information.

As described above, the present invention has an advantage in that a large amount of special information can be provided to the user without purchasing a high-priced device since the special area information of the specialized area is stored in the portable memory, and the special area information is mapped and displayed at the time of running in the specialized area.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A smart navigation system using a portable memory, the system comprising:
the portable memory for storing special area information on a specific area; and
a navigation system having a map database for storing map data, and, when a current measured position is within the specific area, mapping the special area information to the map data and displaying the mapped special area information.

2. The system according to claim 1, wherein the special area information comprises position information of a topography feature of the area, and icon, graphic, or road information representing a name, a lot number, and a feature of the topography feature, and description information of the topography feature.

3. The system according to claim 1, wherein the portable memory is a universal serial bus memory.

4. The system according to claim 1, wherein, upon receipt of a destination, the navigations system searches a path from the current position to the destination, and, when the searched path passes through the specific area, maps the special area information to the map data at the time of guiding a path corresponding to the specific area and displays the mapped area information.

5. The system according to claim 4, wherein the special area information comprises position information of a topography feature of the area, and icon, graphic, or road information representing a name, a lot number, and a feature of the topography feature, and description information of the topography feature.

6. The system according to claim 1, wherein, upon searching a destination, the navigation system searches the special area information for a name having a key word inputted for searching the destination, and, when the name having the inputted key word is searched, maps the special area information on the name to the map data and displays the mapped special area information.

7. The system according to claim 6, wherein the special area information comprises position information of a topography feature of the area, and icon, graphic, or road information representing a name, a lot number, and a feature of the topography feature, and description information of the topography feature.

8. A method for controlling a smart navigation system using a portable memory, the method comprising steps of:
checking a connection or a disconnection of the portable memory storing special area information on a specific area;
in connection of the portable memory, determining whether or not a current measured position is within the specific area; and
when the current measured position is within the specific area, mapping the special area information to map data, and displaying mapped special area information.

9. The method according to claim 8, wherein the special area information comprises position information of a topography feature of the area, and icon, graphic, or road information representing a name, a lot number, and a feature of the topography feature, and description information of the topography feature.

10. A method for controlling a smart navigation system using a portable memory, the method comprising steps of:
if a destination is inputted, searching a path from a current measured position to the destination;
checking a connection or a disconnection of the portable memory storing special area information on a specific area;
in connection of the portable memory, determining whether or not the searched path passes through the specific area; and
when the searched path passes through the area, mapping the special area information to map data, and displaying the mapped special area information.

11. The method according to claim 10, wherein the special area information comprises position information of a topography feature of the area, and icon, graphic, or road information representing a name, a lot number, and a feature of the topography feature, and description information of the topography feature.

12. The method according to claim 10, further comprising steps of:
if a name search mode is selected at the time of checking whether or not a destination input mode is selected, checking whether or not a name for searching the destination is inputted by a user;
when the name is inputted, checking the connection or the disconnection of the portable memory storing the special area information on the specific area;
in connection of the portable memory, determining whether or not there is special area information having a name corresponding to the name among the special area information; and
if there is the name corresponding to the name, mapping the special area information having the name to map data, and displaying the mapped special area information.

13. The method according to claim 12, wherein the special area information comprises position information of a topography feature of the area, and icon, graphic, or road information representing a name, a lot number, and a feature of the topography feature, and description information of the topography feature.
